(19) United States
(12) Patent Application Publication
(10) Pub. No.: US 2008/0195426 A1
(43) Pub. Date: Aug. 14, 2008

(54) Subscription-Based Mobile Shelter Method

(76) Inventor: Barrett H. Moore, Winnetka, IL (US)

Correspondence Address: FITCH EVEN TABIN AND FLANNERY, 120 SOUTH LA SALLE STREET, SUITE 1600, CHICAGO, IL, 60603-3406, US

(21) Appl. No.: 11/470,156

(22) Filed: Sep. 5, 2006

Related U.S. Application Data
(63) Continuation-in-part of application No. 11/384,037, filed on Mar. 17, 2006.
Application No. 11/384,037 is a continuation-in-part of application No. 11/394,350, filed on Mar. 30, 2006.
Application No. 11/394,350 is a continuation-in-part of application No. 11/279,333, filed on Apr. 11, 2006.
Application No. 11/279,333 is a continuation-in-part of application No. 11/379,929, filed on Apr. 24, 2006.
Application No. 11/379,929 is a continuation-in-part of application No. 11/381,247, filed on May 2, 2006.
Application No. 11/381,247 is a continuation-in-part of application No. 11/381,257, filed on May 2, 2006.
Application No. 11/381,257 is a continuation-in-part of application No. 11/381,265, filed on May 2, 2006.
Application No. 11/381,265 is a continuation-in-part of application No. 11/381,277, filed on May 2, 2006.
Application No. 11/381,277 is a continuation-in-part of application No. 11/383,022, filed on May 12, 2006.
Application No. 11/383,022 is a continuation-in-part of application No. 11/420,594, filed on May 26, 2006.
Application No. 11/420,594 is a continuation-in-part of application No. 11/421,694, filed on Jun. 1, 2006.
Application No. 11/421,694 is a continuation-in-part of application No. 11/423,594, filed on Jun. 12, 2006.
Application No. 11/423,594 is a continuation-in-part of application No. 11/425,043, filed on Jun. 19, 2006.
Application No. 11/425,043 is a continuation-in-part of application No. 11/426,231, filed on Jun. 23, 2006.
Application No. 11/426,231 is a continuation-in-part of application No. 11/456,472, filed on Jul. 10, 2006.
Application No. 11/456,472 is a continuation-in-part of application No. 11/461,605, filed on Aug. 1, 2006.
Application No. 11/461,605 is a continuation-in-part of application No. 11/461,624, filed on Aug. 1, 2006.
Application No. 11/461,624 is a continuation-in-part of application No. 11/462,795, filed on Aug. 7, 2006.
Application No. 11/462,795 is a continuation-in-part of application No. 11/462,845, filed on Aug. 7, 2006.
Application No. 11/462,845 is a continuation-in-part of application No. 11/464,751, filed on Aug. 15, 2006.
Application No. 11/464,751 is a continuation-in-part of application No. 11/464,764, filed on Aug. 15, 2006.
Application No. 11/464,764 is a continuation-in-part of application No. 11/464,775, filed on Aug. 15, 2006.
Application No. 11/464,775 is a continuation-in-part of application No. 11/464,788, filed on Aug. 15, 2006.
Application No. 11/464,788 is a continuation-in-part of application No. 11/464,799, filed on Aug. 15, 2006.
Application No. 11/464,799 is a continuation-in-part of application No. 11/465,063, filed on Aug. 16, 2006.
Application No. 11/465,063 is a continuation-in-part of application No. 11/466,727, filed on Aug. 23, 2006.
Application No. 11/466,727 is a continuation-in-part of application No. 11/466,953, filed on Aug. 24, 2006.
Application No. 11/466,953 is a continuation-in-part of application No. 11/381,677, filed on May 4, 2006.
(60) Provisional application No. 60/820,628, filed on Jul. 28, 2006.

(51) Int. Cl. G06Q 10/00

(52) U.S. Cl. 705/5

(57) ABSTRACT

A mobile shelter is provided (101) and consideration-based private civil security subscriptions are accepted (102) from subscribers with respect to providing civilly-catastrophic event-based access to the mobile shelter. By one optional approach, the mobile shelter may be configured and arranged to be moved to and from a predetermined location before, during, and/or after the event. The mobile shelter may be configured and arranged to travel compatibly on or in a variety of surfaces and mediums. Further, the mobile shelter may be a self-powered mobile shelter or a non-self-powered mobile shelter. By one optional approach, a plurality of mobile shelters may be provided and at least two of the plurality of mobile shelter may be coupled (103) together such that a self-powered vehicle can simultaneously transport the at least two shelters.

### RELATED APPLICATIONS

This application claims the benefit of U.S. Provisional Application No. 60/820,628, filed Jul. 28, 2006, which is hereby incorporated in its entirety herein.

This application comprises a continuation-in-part of each of:

SUBSCRIPTION-BASED PRIVATE CIVIL SECURITY FACILITATION METHOD as filed on Mar. 17, 2006 and having application Ser. No. 11/384,037;

SUBSCRIPTION-BASED CATASTROPHE-TRIGGERED MEDICAL SERVICES FACILITATION METHOD as filed on Mar. 30, 2006 and having application Ser. No. 11/394,350;

PERSONAL PROFILE-BASED PRIVATE CIVIL SECURITY SUBSCRIPTION METHOD as filed on Apr. 11, 2006 and having application Ser. No. 11/279,333;

RADIATION SHELTER KIT APPARATUS AND METHOD as filed on Apr. 24, 2006 and having application Ser. No. 11/379,929;

FRACTIONALLY-POSSESSED UNDERGROUND SHELTER METHOD AND APPARATUS as filed on May 2, 2006 and having application Ser. No. 11/381,247;

SUBSCRIPTION-BASED CATASTROPHE-TRIGGERED TRANSPORT SERVICES FACILITATION METHOD AND APPARATUS as filed on May 2, 2006 and having application Ser. No. 11/381,257;

SUBSCRIPTION-BASED MULTI-PERSON EMERGENCY SHELTER METHOD as filed on May 2, 2006 and having application Ser. No. 11/381,265;

SUBSCRIPTION-BASED CATASTROPHE-TRIGGERED RESCUE SERVICES FACILITATION METHOD AND APPARATUS as filed on May 2, 2006 and having application Ser. No. 11/381,277;

POSITIVE PRESSURE FILTRATION KIT APPARATUS AND METHOD as filed on May 4, 2006 and having application Ser. No. 11/381,677;

DOCUMENT-BASED CIVILLY-CATASTROPHIC EVENT PERSONAL ACTION GUIDE FACILITATION METHOD as filed on May 12, 2006 and having application Ser. No. 11/383,022;

RESCUE CONTAINER METHOD AND APPARATUS as filed on May 26, 2006 and having application Ser. No. 11/420,594;

PURCHASE OPTION-BASED EMERGENCY SUPPLIES PROVISIONING METHOD as filed on Jun. 1, 2006 and having application Ser. No. 11/421,694;

SUBSCRIPTION-BASED PRE-PROVISIONED TOWABLE UNIT FACILITATION METHOD as filed on Jun. 12, 2006 and having application Ser. No. 11/423,594;

RADIATION-BLOCKING BLADDER APPARATUS AND METHOD as filed on Jun. 19, 2006 and having application Ser. No. 11/425,043;

PRIVATE CIVIL DEFENSE-THEMED TELEVISION BROADCASTING METHOD as filed on Jun. 23, 2006 and having application Ser. No. 11/426,231;

EMERGENCY SUPPLIES PRE-POSITIONING AND ACCESS CONTROL METHOD as filed on Jul. 10, 2006 and having application Ser. No. 11/456,472;

PRIVATE CIVIL DEFENSE-THEMED BROADCASTING METHOD as filed on Aug. 1, 2006 and having application Ser. No. 11/461,605;

METHOD OF PROVIDING VARIABLE SUBSCRIPTION-BASED ACCESS TO AN EMERGENCY SHELTER as filed on Aug. 1, 2006 and having application Ser. No. 11/461,624;

SUBSCRIPTION-BASED INTERMEDIATE SHORT-TERM EMERGENCY SHELTER METHOD as filed on Aug. 7, 2006 and having application Ser. No. 11/462,795;

SUBSCRIPTION-BASED CATASTROPHE-TRIGGERED RESCUE SERVICES FACILITATION METHOD USING WIRELESS LOCATION INFORMATION as filed on Aug. 7, 2006 and having application Ser. No. 11/462,845;

PRIVATELY PROVISIONED SURVIVAL SUPPLIES DELIVERY METHOD as filed on Aug. 15, 2006 and having application Ser. No. 11/464,751;

PRIVATELY PROVISIONED SURVIVAL SUPPLIES SUB-UNIT-BASED DELIVERY METHOD as filed on Aug. 15, 2006 and having application Ser. No. 11/464,764;

PRIVATELY PROVISIONED SURVIVAL SUPPLIES ACQUISITION METHOD as filed on Aug. 15, 2006 and having application Ser. No. 11/464,775;

PRIVATELY PROVISIONED SURVIVAL SUPPLIES CONTENT ACQUISITION METHOD as filed on Aug. 15, 2006 and having application Ser. No. 11/464,788;

METHOD TO PRIVATELY PROVISION SURVIVAL SUPPLIES THAT INCLUDE THIRD PARTY ITEMS as filed on Aug. 15, 2006 and having application Ser. No. 11/464,799;

WASTE DISPOSAL DEVICE as filed on Aug. 16, 2006 and having application Ser. No. 11/465,063;

SUBSCRIPTION-BASED PRIVATE CIVIL SECURITY RESOURCE CUSTOMIZATION METHOD as filed on Aug. 23, 2006 and having application Ser. No. 11/466,727;

PREMIUM-BASED PRIVATE CIVIL SECURITY POLICY METHODS as filed on Aug. 24, 2006 and having application Ser. No. 11/466,953;

the contents of which are fully incorporated herein by this reference.

### TECHNICAL FIELD

This invention relates generally to shelters.

### BACKGROUND

As powerful as the machinery of modern life appears, modern citizens are today perhaps more at risk of experiencing a serious disruption in their ability to prosper or even to survive en mass than is generally perceived. A serious disruption to any significant element of civilized infrastructure can produce catastrophic results for a broad swatch of a given civil community. Any number of natural and/or intentionally-caused events can significantly disrupt society's infrastructure and present a variety of differing threats and problems to the individual.

Many people believe and trust that their government (local, regional, and/or national) will provide for them in the event of such catastrophic occurrences. And, indeed, in the long view such is clearly a legitimate responsibility owed by any government to its citizens. That such is a consummation devoutly to be wished, however, does not necessarily make it so. Hurricane Katrina provided some insight into just how unprepared a series of tiered modern governmental entities may actually be to respond to even basic survival needs when a large-scale catastrophic event occurs. One may also observe that most communities simply cannot afford to staff and support a contingent capability to deal with a wide variety of likely infrequent and possibly unpredictable extreme events.

When a civilly-catastrophic event occurs, substantially sudden civil upheaval will often follow. Not only will many significant elements of society's infrastructure be seriously disrupted, but people in general are known to act in ways that are different and sometimes unexpected when faced with circumstances that threaten their well being or survival. This, coupled with the characterizing effects of the civilly-catastrophic event itself, can present an affected person with numerous challenges. Modern governments typically do little to proactively ensure the ability to quickly and safely effect care of their citizens in the face of many civilly-catastrophic events. These challenges can be particularly troubling for persons located in crowded urban settings. As a result, for example, persons who are caught working at a downtown office or other densely populated area when a civilly-catastrophic event occurs may well find themselves trapped in gridlock in the city without being able to escape or otherwise access shelter to protect themselves at least from the initial effects of the event.

Many catastrophic events are survivable presuming one has access to a suitable emergency shelter. It is possible, of course, to retain the services of skilled shelter builders to thereby personally acquire such a shelter. Such an approach, however, presents a number of corresponding problems and issues. In general, acquiring or constructing such a shelter tends to be costly, is often impractical for a given interested party, and may cause considerable unwanted attention as well. On the other hand, attempting to take responsible actions to reasonably ensure one's own abilities in this regard can become, in and of itself, a seemingly insurmountable challenge. In addition, if an individual does have access to a shelter, they may become stranded at the shelter location with no means of evacuating or transporting themselves to a more secure area. Further, a particular event or occasion may bring an increased number of people to a certain area, such as a population center. If any shelters exist in the area they are likely of limited quantity and capacity and obtaining and/or erecting additional shelters to accommodate the increased crowds poses a significant challenge, particularly upon short notice.

For these and other reasons most if not all persons are typically bereft of a mobile shelter that can be readily and quickly accessed in a time of need and that can be transported to and from predetermined locations.

### BRIEF DESCRIPTION OF THE DRAWINGS

The above needs are at least partially met through provision of the subscription-based mobile shelter method described in the following detailed description, particularly when studied in conjunction with the drawings, wherein:

FIG. 1 comprises a flow diagram as configured in accordance with various embodiments of the invention;

FIG. 2 comprises a side elevational schematic as configured in accordance with various embodiments of the invention;

FIG. 3 comprises a side elevational schematic view as configured in accordance with various embodiments of the invention;

FIG. 4 comprises a side elevational schematic view as configured in accordance with various embodiments of the invention;

FIG. 5 comprises a side elevational schematic view as configured in accordance with various embodiments of the invention;

FIG. 6 comprises a side elevational schematic view as configured in accordance with various embodiments of the invention; and

FIG. 7 comprises a schematic block diagram view as configured in accordance with various embodiments of the invention.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, a mobile shelter is provided and consideration-based private civil security subscriptions are accepted from subscribers with respect to providing civilly-catastrophic event-based access to the mobile shelter. The mobile shelter may be positioned in any of a variety of locations, depending on the type of mobile shelter and the assessment of where a mobile shelter is needed. By one optional approach, the mobile shelter may be configured and arranged to be moved to and from a predetermined location before, during, and/or after the event.

The mobile shelter may be configured and arranged to travel compatibly on or in a variety of surfaces and mediums. Further, the mobile shelter may be a self-powered mobile shelter or a non-self-powered mobile shelter. By one optional approach, a plurality of mobile shelters may be provided and at least two of the plurality of mobile shelter may be coupled together such that a single self-powered vehicle can simultaneously transport the at least two shelters.

In addition, the shelter can be maintained pending a need to permit subscription-based access to the mobile shelter upon occurrence of the event, and an attendant may be provided to assist with the maintenance, security, and transport of the mobile shelter. If desired, emergency survival items may also be provided in the mobile shelter. Adjustments to the emergency shelter items may also be made to reflect dynamically changing circumstances as occur during the consideration-based private civil security subscription.

These teachings can be facilitated without dependency upon governmental oversight, participation, or control. By these teachings, an individual can take important steps to bring security into their lives without having to effectively become a full-time survivalist; such individuals can, in short, continue to enjoy their chosen vocations and standard of living knowing that, should a civilly-catastrophic event indeed be visited upon them, they will have access to a mobile shelter that can provide protection and/or transportation before, during, or after the event that may prove critical to the sustainment of human life.

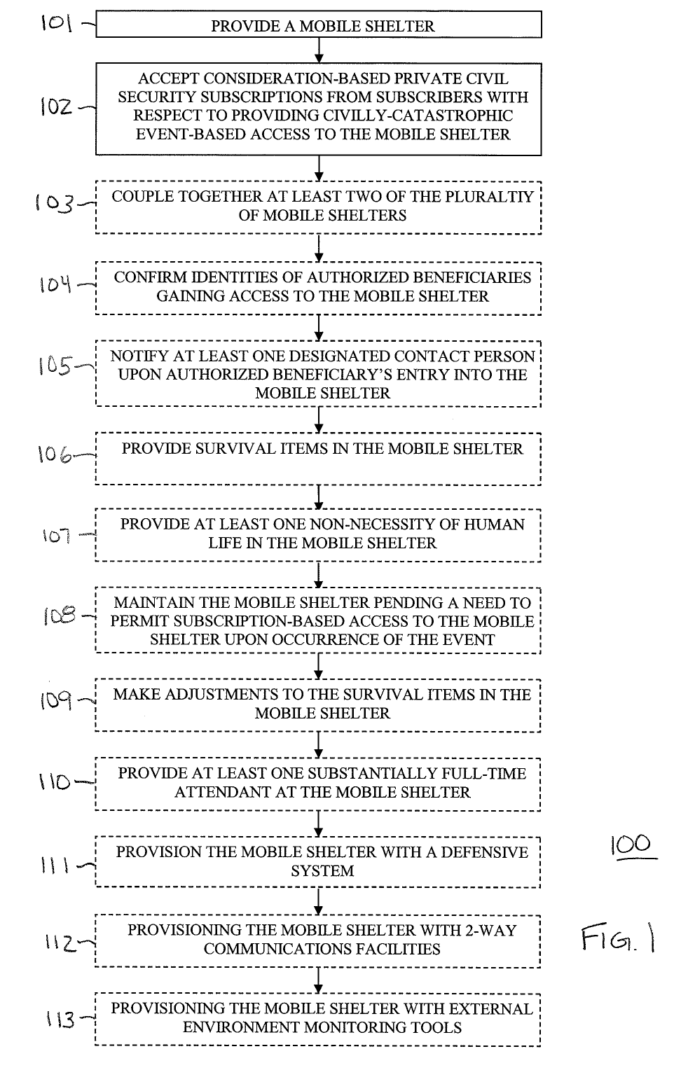

These and other benefits may become clearer upon making a thorough review and study of the following detailed description. Referring now to the drawings, and in particular to FIG. 1, an illustrative process 100 in accord with these teachings provides generally for providing 101 a mobile shelter and accepting 102 consideration-based private civil security subscriptions from subscribers with respect to providing civilly-catastrophic event-based access to the mobile shelter.

Generally, the mobile shelters may comprise short or long term accommodations. The short-term mobile shelter will generally comprise simplified or limited facilities suitable for accommodating a temporary stay within the shelter for a limited number of occupants. The simplified facilities may include, for example, temporary sleeping facilities, hygiene facilities, simple food preparation facilities, storage, and/or communications facilities. Other options for the short-term mobile shelter may include, but are not limited to, auxiliary electric power supplies and sources, lighting, temperature and/or humidity control, water and/or air purification, first aid facilities, and so forth.

A long-term shelter may comprise additional supplies and/or services that may be more appropriate for shelter stays of longer duration. For example, the long-term shelter may comprise both common and private areas, with a greater quantity and variety of supplies (both luxury and non-luxury) being available. The long-term shelter will generally have most of the features of the short-term shelter, however, the long-term accommodations will generally be more elaborate and comprehensive and may include services that are unavailable in a short-term shelter. The long-term shelter may include, for example, medical facilities, water sanitation facilities, lodging facilities, and/or food preparation facilities. In addition, embellishments such as entertainment and educational services and exercise facilities may also be available, to note but a few examples.

The mobile shelter can vary greatly with respect to the actual and/or anticipated circumstances as may concern its eventual use of being transported to or from a location of substantially sudden civil upheaval as has been occasioned by a civilly-catastrophic event. This can include differences with respect to the transport modality (or modalities) that characterize the mobile shelter. Further, the mobile shelter may be configured and arranged to travel compatibly on or in at least one of a variety of surfaces or mediums. Examples include, but are not limited to, paved surfaces, unpaved surfaces, railroad tracks, a liquid medium, an atmospheric medium, or earth.

The mobile shelter may be configured and arranged to transport authorized beneficiaries to another mobile shelter, a fixed short term shelter, and/or a fixed long term shelter. Thus, an authorized beneficiary can be transported out of an area that has come under threat by the civilly-catastrophic event and transitioned to a more secure area or shelter. The authorized beneficiaries may be taken to another mobile shelter that will further transport or evacuate them from the threatened area, or that may transport the authorized beneficiaries to another mobile or fixed shelter. Or the mobile shelter may take the unauthorized beneficiaries to a fixed long term or fixed short term shelter where the authorized beneficiaries can be offered further protection and security on a long term or short term basis, respectively.

The mobile shelter may include self-powered shelters. By one example, the self-powered mobile shelter may comprise, for example, a vehicle. Examples include, but are not limited to, air-borne vehicles (including fixed wing aircraft, helicopters, tiltrotor and hovercraft, to note but a few), terrestrial vehicles (including cars, buses, trucks, recreational vehicles, motorhomes, and trains, to note but a few), subterranean vehicles (including boring machines and vehicles that move through the earth), and water-borne vehicles (including boats and ships, barges, submarines, and amphibious craft, again to note but a few relevant examples). In many cases the vehicle will comprise a piloted vehicle that requires an in-vehicle pilot. If desired, however, the vehicle may also comprise a pilotless vehicle or a remotely piloted vehicle (where the vehicle operates under the control of an automated control system, a remotely-located pilot, or some combination thereof). The vehicle mobile shelter may further optionally comprise a vehicular fuel storage tank and/or fuel pump. As another optional approach, remotely operated fuel points may be provided along a route in order to refuel the shelter.

In some cases the vehicle will comprise a terrestrial vehicle. In such a case it may be useful to configure and arrange the vehicle to be able to traverse off-road conditions. Such a capability may be useful, for example, to successfully move past debris, stalled, blocked, or abandoned vehicles, impassable roadways, and so forth. This can comprise configuring the vehicle with a higher-than-normal suspension, a heavy-duty suspension, all-wheel drive, and so forth. This may also comprise configuring the vehicle's engine to operate even when partially or fully submerged (as may occur when fording a flooded area). Such accoutrements are known in the art and require no further elaboration here.

Additionally, the vehicle may comprise a terrestrial vehicle that has a free-ranging capability to thereby freely navigate paved and unpaved surfaces of various kinds. In some cases, however, it may be useful to further configure and arrange the vehicle to also selectively travel compatibly on railroad tracks. This may comprise, for example, outfitting the vehicle with retractable flanged wheels that can be selectively lowered to interact compatibly with a set of railroad tracks. Such apparatus is known in the art. So configured, the vehicle can selectively readily travel on railroad tracks which may, in a given time of need, comprise a relatively unblocked means of departing from a location of civil upheaval.

By another approach, the mobile shelter may comprise a non-self-powered mobile shelter. As one example, the non-self-powered mobile shelter could be a formerly operational vehicle, such as a bus, recreational vehicle, trailer, boat, or train, for example, that no longer has means for providing self-locomotion. The non-operational vehicle could then be converted and equipped to function as a mobile shelter. The non-self-powered mobile shelter may also comprise, for example, a rail car, glider, trailer, or container. The non-self-powered mobile shelter may be towed, hoisted, lifted, or otherwise transported to and/or from a predetermined location by a self-powered vehicle. The non-self-powered mobile shelter may also be configured and arranged to receive propulsion, a power unit, or other powering device to thus convert the non-self-powered mobile shelter into a self-powered mobile shelter.

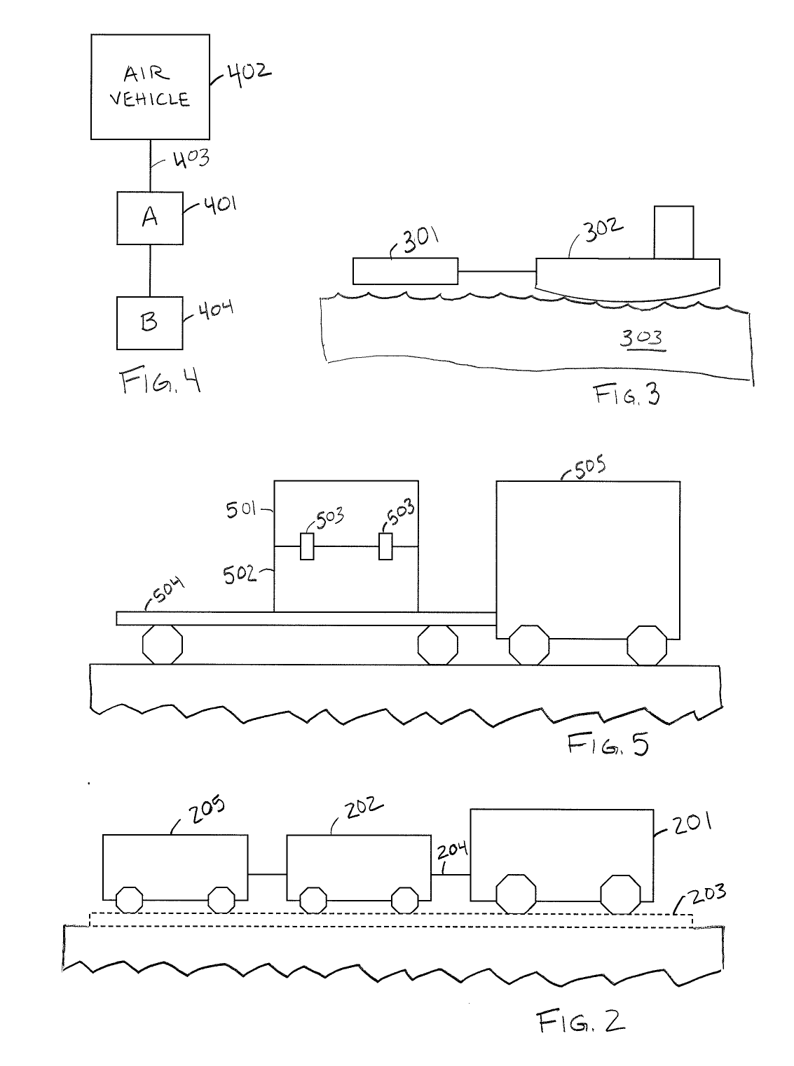

A mobile shelter may be provisioned with wheels, tracks, rails, jets, floats, a hull, pontoons, propellers, skids, and so forth, to facilitate selective movement of the shelter. By another optional approach, the mobile shelter may be configured and arranged to be towed, driven, transported or otherwise moved by a self-powered vehicle. The mobile shelter may be moved or driven onto a platform, structure, vessel, or support, hoisted, lifted or towed by a self-powered vehicle. The mobile shelter being towed or moved may be self-powered or non-self-powered. This may comprise, for example, a trailer 201 that is towed and transported by a truck 202, as shown in FIG. 2. By another approach, the shelter may comprise rail cars that are pulled by a train, or tracks 203 may be used to facilitate movement of a trailer. As yet another option, as shown in FIG. 3, a boat 301 or other water-borne platform may be towed or pushed by another boat 302 or water-borne vehicle in water 303. A mobile shelter 401 may also be configured and arranged to be hoisted into the air and towed by an airborne vehicle 402, as shown in FIG. 4. Countless other examples exist.

Depending on the transport modality and/or the type of self-powered vehicle or mobile shelter being used, the mobile shelter and self-powered vehicle may be configured to accommodate any of a variety of interfaces to facilitate the interconnection of the vehicle and shelter such that the shelter may be transported. For example, the mobile shelter may interface with the vehicle using a lift-line interface 403 when being airlifted by an airborne vehicle 402, as shown in FIG. 4. Referring again to FIG. 2, a chain or cable 204 may be used to tow the trailer. The interface may also comprise a rope, a cradle, a hook, a magnet, or other coupling device, to name but a few examples. Various kinds of interface equipment are known in the art and any or all may be used to connect or otherwise interface a self-powered vehicle and a mobile shelter.

In addition, a plurality of mobile shelters may be provided. The plurality of shelters may be located in the same general area or population center, as well as in a plurality of locations or population centers. It may be desirable to interconnect multiple mobile shelters for transportation purposes. By one optional approach, and referring again to FIG. 1, at least two of the plurality of mobile shelters can be coupled 103 together such that a self-powered vehicle can simultaneously transport the at least two mobile shelters. Various kinds of coupling equipment are known in the art and others will likely be developed in the future. These teachings are generally compatible for use with any or all such approaches. Accordingly, the at least two of the plurality of mobile shelters may be interconnected in a series. Thus, for example, a land, air, water, or rail train may be created.

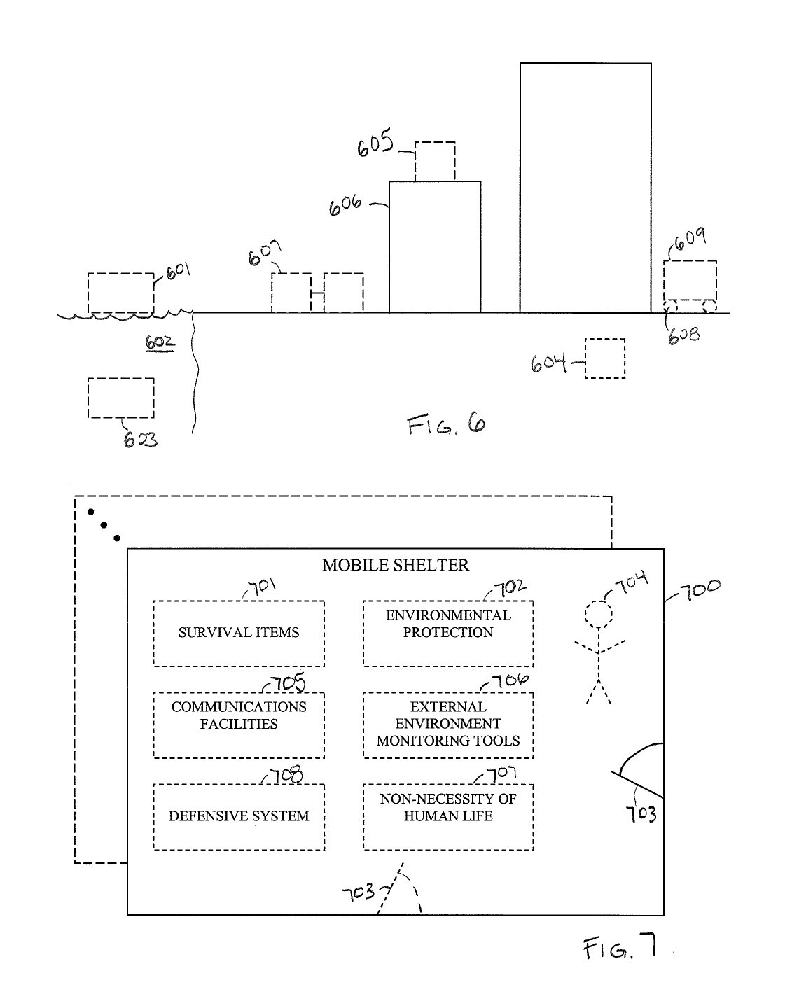

Referring again to FIG. 2, a second trailer 205 may be coupled to the first trailer 202 and towed by the same truck 201. Or, if desired, the stacked shelters may be transported by air, such as shown in FIG. 4, with a second mobile shelter 404 coupled in series with the first mobile shelter 401. By another optional approach, the plurality of mobile shelters may be coupled together in a stacked configuration. The stacked configuration may be placed on a self-powered vehicle to thus provide transportation of the mobile shelters. Countless possibilities exist. For example, and referring now to FIG. 5, a first mobile shelter 501 may be stacked on a second mobile shelter 502 and secured together with straps 503 or other tethering device. The stacked shelters 501, 502 may be placed on a bed 504 of a truck 505 to be transported.

Providing such a shelter can further comprise, if desired, prepositioning the mobile shelter at a predetermined location. In many cases it may be helpful to dispose such a predetermined location relatively proximal to one or more authorized beneficiaries, and particularly relatively near or within a population center or large metropolitan areas where many authorized beneficiaries may be located. Such a location may be preferable for the mobile shelter because relative proximity between the shelter and the authorized beneficiaries may be advantageous when anticipating catastrophic events that may occur in a devastating fashion with relatively little advance notice. Further, the likelihood of traffic paralysis in a population center is fairly high upon the occurrence of a catastrophic event, as many people may be trying to avoid the effects of the event or otherwise remove themselves from the population center. Thus, having a mobile shelter located within the population center will help facilitate access to the shelter during the window of clear and present threat exposure.

Such a position may aid with facilitating timely access to the mobile shelters for the authorized beneficiaries during a time of need. Such proximity may be measured, for example, by distance and/or by a period of time as may reasonably be required to traverse the distance between at least some of the authorized beneficiaries and the predetermined location of the shelter. In some cases, as when the authorized beneficiaries reside or are otherwise often located within a significant population center (such as a city or large town) it may be useful to dispose a (or an additional) mobile shelter at a predetermined location within the population center itself.

Sensitivities in this regard may vary in response to various influences including but not limited to authorized beneficiary locations, applicable relevant threat scenarios and threat locations, and the like. Therefore, prepositioning the shelter at a predetermined location may further comprise assessing a likelihood of at least one particular event occurring and also assessing a likelihood of a location of the at least one particular event occurring. This would include, for example, evaluating when tensions, conditions, and/or concerns regarding the occurrence of a particular event are relatively high. The mobile shelter may then be placed strategically based on the intelligence information that is gathered regarding the type of threat and possible location where such an event may occur.

Further, the predetermined location may be a permanent or temporary location for a mobile shelter. For example, a particular event or occasion may bring an increased number of authorized beneficiaries to a certain area, such as a population center. If the existing mobile shelters in that area will not be able to accommodate the additional or concentrated number of authorized beneficiaries should a catastrophic event occur, it may be desirable to provide additional mobile shelters proximal to the authorized beneficiaries. These additional mobile shelters may optionally comprise temporary shelters that are only positioned near the authorized beneficiaries for the duration of the event or occasion that brought them to the area.

Authorized beneficiaries could be provided with information regarding the location of the mobile shelters as well as information regarding how to access the shelters. This information can be provided prior to the occurrence of the catastrophic event if desired using any available or known communications devices or techniques. It may also be useful or possible to provide such information (either in the first instance or as a supplemental notice) following the initiation of such an event. The latter may be achieved using such communication means as may be available at the time. It would also be possible to provision each authorized beneficiary (or family or company of beneficiaries) with one or more communications devices by which such information could be provided.

An authorized beneficiary may also be provided with a beacon that the authorized beneficiary can activate to transmit a signal when a civilly-catastrophic event occurs. The mobile shelter can be configured and arranged to receive the transmitted beacon signal and may respond by following the signal and moving to the location of the authorized beneficiary. The response to the beacon signal may be automatic, non-automatic, and/or partially automatic. Thus, the authorized beneficiaries may be picked up by the mobile shelter, with the mobile shelter coming to the authorized beneficiaries rather than the authorized beneficiaries having to go to the mobile shelter. By another optional approach, the authorized beneficiaries may need to travel to a predetermined designated meeting location. A beacon may be provided at the designated meeting location, with the beacon being activated to transmit a signal when the authorized beneficiaries gather at the meeting location. Upon receiving the beacon signal, the mobile shelter may then follow the signal and move to the meeting location to pick up the authorized beneficiaries.

As the shelter is mobile, the shelter may be configured and arranged to be moved to and from the predetermined location before, during, and/or after the civilly-catastrophic event. The mobile nature of the shelter, particularly post-event, can make this shelter particularly suitable to function as a transitional shelter. Thus, the mobile shelter not only provides substantial protection from the threat of the catastrophic event but may also transport its occupants to an area of safety or rescue, or another shelter, for example. This option may be particularly helpful if the clear and present threat exposure is so eminent, extended, and/or severe that evacuation from the predetermined location becomes necessary.

Or, if desired, the mobile shelter may remain stationary in the predetermined location while authorized beneficiaries of the consideration-based private civil security subscriptions occupy the mobile shelter. Thus, the transportability or mobility of the mobile shelter may be reserved for use before and/or after the event that triggers access to the shelter. For example, the mobile capabilities of the shelter could be utilized only to initially position the mobile shelter in a predetermined location. Once positioned, the mobile shelter would then remain stationary in the predetermined location while authorized beneficiaries occupy the shelter. Then, if desired, the mobile shelter may be moved from the predetermined location after the authorized beneficiaries exit the mobile shelter. The mobile shelter may then be transported to another location, such as, for example, a restocking or maintenance area, or to another predetermined location.

As noted, the subscriptions relate to providing event-based access to the mobile shelter. The event-based access may comprise, for example, civilly-catastrophic event-based access. As used herein, “civilly-catastrophic event” will be understood to refer to an event that substantially and materially disrupts a society's local, regional, and/or national infrastructure and ability to provide ordinary civil services. A civilly-catastrophic event can be occasioned by any of a wide variety of natural and/or non-naturally-caused disasters. Examples of natural disasters that are potentially capable of initiating a civilly-catastrophic event include, but are not limited to, extreme weather-related events (such as hurricanes, tsunamis, extreme droughts, widespread or unfortunately-targeted tornadoes, extreme hail or rain, and the like, flooding, and so forth), extreme geological events (such as earthquakes, volcanic activity, and so forth), extreme space-based events (such as Earthly collisions with comets, large asteroids, and so forth, extreme solar flares, and the like), extreme environmental events (such as widespread uncontrolled fire or the like), and global or regional pandemics, to note but a few.

Examples of non-naturally-caused disasters capable of initiating a civilly-catastrophic event include both unintended events caused by various intentional and unintentional behaviors and actions such as acts of war, terrorism, madness, accident, or the like. Examples of non-naturally-caused disasters capable of such potential scale include, but are not limited to, nuclear-related events (including uncontrolled fission or fusion releases, radiation exposure, and so forth), acts of aggression such as war or terrorism, the release of deadly or otherwise disruptive biological or chemical agents or creations, and so forth.

Emergency shelters comprise a generally well-understood area of endeavor with various construction techniques, architectural choices, and materials options being known. Generally, the mobile shelter comprises an enclosed structure or vehicle. Such a configuration provides substantial protection for the occupants of the shelter. The mobile shelter is generally configured and arranged to be a barrier to threat exposure created by the event. Therefore, several options and configurations are possible. These options and configurations may vary with regard to the type of structure or vehicle that is being used as the mobile shelter. For the purpose of illustration and not limitation, and referring now to FIG. 6, certain approaches that may be taken with respect to providing such a mobile shelter will be presented.

If desired, a mobile shelter can be configured and arranged to float in a liquid such as fresh water or salt water bodies. A floating mobile shelter 601 is shown in FIG. 6 floating on a body of water 602. This may be helpful, for example, during a land-based catastrophic event, or when land space is in limited supply. Further, a floating mobile shelter 601 may be desired when liquid may be needed as a transportation medium for the mobile shelter either to or from a particular pre-determined location where the shelter will be positioned. In addition, a mobile shelter may be configured and arranged to be submergible. A submerged mobile shelter 603 is shown in FIG. 6 immersed in the body of water 602. Submerging the mobile shelter may be particularly beneficial during certain types of threats or events, such as, for example, radiation exposure or widespread fire. Further, the floating shelter 601 or the submerged shelter 603 may also comprise water-borne vehicles.

By another approach, the mobile shelter may be substantially fireproof. For example, the mobile shelter may be at least partially comprised of heat resistant material to thereby aid in preventing the interior of the mobile shelter from becoming unsuitable for human habitation due to fire within or around the location of the shelter. If desired, the mobile shelter may also be substantially waterproof. This feature is particularly desirable in the case of certain extreme weather-related events (such as, for example, tsunamis, rain, flooding, and so forth) and this feature is highly desirable for the floating or submergible mobile shelters.

The shelter may be enclosed in a radiation-blocking bladder to provide protection to the shelter occupants. The radiation-blocking bladder may be used in addition to or in lieu of placing the mobile shelter underground. The radiation-blocking bladder may be at least substantially filled with liquid (such as, but not limited to, water) to comprise a radiation barrier. Alternatively (or in combination therewith), the walls, ceiling and/or floor of the mobile shelter may incorporate, or be encased by, ionizing radiation shielding such that part, or all, of the mobile shelter is shielded.

By another optional approach, the mobile shelter may be armored or otherwise fortified. The armor can be designed to stop at least low caliber small arms fire and may offer higher ballistic protection if desired, including bulletproof windows, louvered view ports, and armored occupant compartments, to note but a few examples. Further, the mobile shelter may have ports to deploy weapons. Additionally, the mobile shelter may be otherwise structurally hardened to resist collapse or breach.

At least some civilly-catastrophic events that prompt a need for rescue as per these teachings may be accompanied by an electromagnetic pulse. Such a pulse can permanently damage many electrical circuits including, for example, the electronic engine controls for a vehicle. With this in mind, it may be desirable to harden at least the critical vulnerable systems of the mobile shelter to thereby substantially protect those systems against an electromagnetic pulse. Again, various ways and means of achieving such a result are known in the art and may be practiced here as desired.

The mobile shelter may be configured and arranged to be disposed underground to comprise an underground mobile shelter 604. The underground mobile shelter may optionally be buried and covered by earth. An underground configuration would provide protection from a multitude of threats. Specifically, for a radioactive threat, having a considerable mass placed between the underground shelter inhabitants and the source of radioactivity would provide protection to the shelter occupants. Thus, the mobile shelter may be covered by at least 2 meters of earth. This depth can vary, of course, with the nature of the dirt itself, as a greater depth below less dense earth may be necessary to provide a same level of radiation blockage as a lesser depth of more dense earth. The underground mobile shelter may comprise a subterranean mobile shelter that can move through the earth.

By another approach such a mobile shelter could be transported to and used in conjunction with an underground parking facility to thereby permit the mobile shelter to become, in effect, an underground shelter 604. One or more parking spots may be reserved or rented within the parking facility for the mobile shelter. The mobile shelter may then be transported to the parking facility and positioned there on either a temporary or permanent basis.

Alternatively, the mobile shelter may comprise an above ground, elevated mobile shelter 605. The above ground mobile shelter 605 may be located on land or an upper floor of a structure, such as, for example, a building 606. Again, the above ground mobile shelter may be created by customizing an existing space or may be created by constructing a new space for the shelter. By one optional approach, the building may comprise an above ground parking facility. Similarly to the underground parking facility, one or more parking spots may be reserved within the parking facility for the mobile shelter. It may be desirable to position the mobile shelters on a top floor or roof of the parking facility or other building such that a helicopter or other air vehicle may lift the mobile shelter from the top floor or roof and transport the shelter to another location. As discussed, the mobile shelter may have a lift-line interface, cradle, or other coupling device to facilitate airborne movement of the shelter. Alternatively, as discussed, the mobile shelters may also be coupled and transported together in a train 607, such as, for example, when being transported to or from the parking facility or other predetermined location. In addition, the mobile shelter may also have wheels 608 to facilitate movement of a mobile shelter 609 to and from the predetermined location

As mentioned, the process 100 provides for accepting 102 consideration-based private civil security subscriptions from subscribers with respect to providing event-based access to the mobile shelter. The event-based access to the mobile shelter can pertain, if desired, to a predetermined period of time. For example, a given subscription can relate to providing access to the mobile shelter for a one year period of time for one or more authorized beneficiaries as correspond to that subscription.

By one approach, these subscriptions may be accepted by, for example, a for-profit business. By another approach a not-for-profit business (such as a membership-based entity) may be the appropriate entity to offer and accept such subscriptions.

As noted, these teachings provide for a subscription-based approach. As used herein, the term “subscription” shall be understood to refer to and encompass a variety of legal mechanisms. Some relevant examples include, but these teachings are not limited to, subscription mechanisms such as:

time-limited rights of access (as where a subscription provides access rights for a specific period of time, such as one year, in exchange for a corresponding series of payments);

event-limited rights of access (as where a subscription provides access rights during the life of a given subscriber based upon an up-front payment in full and where those access rights terminate upon the death of the subscriber or where, for example, a company purchases

a subscription for a key employee and those corresponding rights of access terminate when and if that key employee leaves the employment of that company);

inheritable rights of access (as may occur when the subscription, by its own terms and conditions, provides a right of access that extend past the death of a named subscription beneficiary and further provides for testate and/or intestate transfer to an heir);

rights of access predicated upon a series of periodic payments (as where a subscription provides access rights during, for example, predetermined periods of time on a periodic basis as where a subscriber offers a payment on a month-by-month basis to gain corresponding month-by-month access rights);

rights of access predicated upon a one-time payment (as may occur when a subscriber makes a single payment to obtain a time-based or event-based duration of access rights or, if desired, when a single payment serves to acquire a perpetual right of access that may be retained, transferred, inherited, or the like);

ownership-based rights of access (as may occur when the subscription provides for ownership rights that pertain to a portion of the shelter);

non-transferable rights of access (as may occur when the subscription, by its terms and conditions, prohibits transfer of the right of access from a first named beneficiary to another);

transferable rights of access (as may occur when the subscription, by its terms and conditions, permits, conditional or unconditional transfer of the right of access from a first named beneficiary to another);

membership-based rights of access (as may occur when the subscription, by its terms and conditions, establishes a membership interest with respect to the accorded right of access such as, for example, a club-based membership);

fractionally-based rights of access (as may occur when the subscription, by its terms and conditions, establishes a divided or undivided co-ownership interest by and between multiple subscription beneficiaries with respect to a right to access);

non-ownership-based rights of access (as may occur when the subscription, by its terms and conditions, establishes the aforementioned right of access via, for example, a lease, rental, or borrowing construct); and/or

option-based rights of access.

If desired, a plurality of differentiated subscription opportunities can be offered in this regard. This plurality of differentiated subscription opportunities can correspond, for example, to providing access to the plurality of mobile shelters. As but one very simple illustration in this regard, such subscription opportunities can differ from one another at least with respect to cost. This, in turn, provides subscriber choice with respect to selecting a particular subscription that best meets their specific needs and/or budget limitations. For example, a less costly subscription may provide event-based access to only one of the plurality of mobile shelters, while another subscription opportunity may provide access to more than one of the plurality of mobile shelters at an increased subscription cost. A more costly subscription option may provide access to any of the plurality of mobile emergency shelters. Further, at least one of the plurality of mobile shelters may comprise accommodations and features that differ from another one of the plurality of mobile shelters. Thus, the subscriptions may differ from one another with respect to which accommodations and features are accessible as per the subscription.

These teachings also readily encompass the notion of a given subscriber providing such a subscription for an authorized beneficiary other than themselves. Such might occur, for example, when one family member procures such a subscription for one or more other family members. Another example would be for a company to subscribe on behalf of named key employees, family members of such key employees, and so forth. Other examples no doubt exist.

Referring again to FIG. 1, the process 100 may optionally provide for confirming 104 the identities of authorized beneficiaries gaining (or seeking to gain) access to the mobile shelter. Further, the authorized status of authorized beneficiaries may also be confirmed upon verification and confirmation of their identity. The identities of the authorized beneficiaries may be confirmed or authenticated, for example, by at least one identification mechanism, such as biometrics (such as retinal patterns, asperity patterns, voice recognition, or some other relatively unique aspect of the human body), identification cards, photographic identification, visual confirmation, an admission card, a password or pass code, a signature, or words and phrases, to note but a few illustrative examples. Identification confirmation may also include confirmation that the authorized beneficiary is allowed entry into a particular mobile shelter.

By another optional approach, at least one designated contact person (such as a spouse, parent, child, or other keenly interested stakeholder) may be notified 105 upon confirmation of the authorized beneficiary's identity and the subsequent entry of the authorized beneficiary into the mobile shelter. The notification may be automatic, partially automatic, or non-automatic (i.e., manual). This information may be communicated to the at least one designated contact person using any of a variety of communications facilities provided in the mobile shelter, as further described below.

Referring again to FIGS. 1 and 7, the process 100 may optionally provide for providing 106 survival items 701 in the mobile shelter 700. This can comprise, for example, providing a plurality of life-sustaining resources as pertain to a plurality of differing categories of life's necessities (such as, but not limited to, hydration, nourishment, shelter, clothing, security, medical treatment, environmentally borne threat abatement, and so forth).

By one approach, the emergency survival items 701 can comprise, at least in part, consumable survival supplies. Illustrative examples include, but are not limited to:

food supplies;

potable water;

a finite air supply;

medical supplies (including, but not limited to, first aid supplies as well as first responder emergency medical services supplies such as blood, plasma, automatic external defibrillators, radiation exposure treatments, chemical exposure treatments, antibiotics, and so forth);

batteries;

hygiene supplies;

ammunition;

supplemental vehicular fuel supplies (carried in on-board auxiliary fuel tanks and/or non-integral fuel containers of choice); and

sanitation supplies.

In addition, or in lieu thereof, the supplies can comprise, at least in part, non-consumable survival supplies. Illustrative examples include, but are not limited to:

essential clothing items;

body armor and protective gear;

personal protection items (such as face masks, gloves, foul-weather gear, and so forth);

bed linens;

beds (including cots, hammocks, and so forth);

food preparation items;

communications items;

power generation equipment;

repair and maintenance tools;

evacuation tools (such as cutting torches, cement saws, and other tools that can be used to create another point of egress from the shelter should that be necessary);

navigation equipment (such as maps (in hardcopy and/or virtual form), global positioning system-based equipment and aids instructions, a compass, diagrams of the shelter and/or surrounding buildings and facilities, and so forth);

rescue tools and supplies (such as rope, a locator apparatus, beacons, noise makers, a self-inflatable raft or other floatation equipment, emergency lights, climbing equipment, and so forth);

radiation shielding;

biological/chemical agent protection;

spare vehicle parts (including but not limited to mission critical parts relating to the vehicle's drive train, propulsion system, trajectory controls, and so forth);

self-rescue gear;

vehicular maintenance tools; and

weapons.

The mobile shelter may contain a short-term supply of emergency survival items to sustain the occupants during the window of clear and present threat exposure temporally proximal to the event. The short-term supply will assist in sustaining the authorized beneficiaries while in the shelter and prior to the opportunity to access any other type of necessities or survival items from another source. Alternatively, the mobile shelter 700 may contain a long-term supply of emergency survival items 701 to sustain the authorized beneficiaries for a longer period of time, particularly if the mobile shelter is used as a long-term shelter. Again, the types of supplies may also vary depending on the duration of the stay of the beneficiaries.

This process 100 will also optionally accommodate providing 107 at least one non-necessity of life 707 in the mobile shelter 700. Illustrative examples in this regard might include, but are not limited to:

luxury consumable items;

luxury non-consumable items;

non-essential clothing;

non-human accommodations and nourishment (such as pet food, pet toys and accessories, cages for transport or restraint of animals, and so forth);

barter medium (including, for example, precious metals in a convenient barterable form);

an entertainment apparatus;

an educational tool;

physical conditioning, exercise, and maintenance training and equipment;

crafts supplies and training; and

sports equipment and facilities; to note but a few.

The mobile shelter may also comprise storage space for authorized beneficiaries. The storage space may be provided for any of a variety of needs and supplies, including but not limited to private and/or commonly-shared food supplies, potable water, medical supplies, hygiene supplies, clothing items, towels, bed linens, food preparation items, communication items; and entertainment items, to again note but a few.

The process 100 may further optionally provide for maintaining 108 the mobile shelter pending a need to permit the subscription-based access to the mobile shelter upon occurrence of the event. This can comprise maintaining the shelter on behalf of the subscriber and/or the authorized beneficiaries. The specifics of such maintenance will of course vary with respect to the nature of the resource or resources being maintained. Such maintenance can comprise, for example, maintaining both operational serviceability of the mobile shelter as well as the utility of the emergency survival items as provided therein. By one approach such maintenance can comprise ensuring that unauthorized persons do not access the shelter, inspecting and/or testing the structural and operational integrity of the shelter and its constituent elements, components, and systems, and/or ensuring that pre-provisioned supplies are properly stored, fresh, and suitable for use should the need arise, to name but a few examples. Further, because these shelters are mobile, the shelter may require maintenance related to the particular transport features of the mobile shelter.

Such maintenance can also optionally comprise making 109 adjustments to the emergency survival items in the mobile shelter to reflect dynamically changing circumstances as occur during the consideration-based private civil security subscription. As one illustration, a new item may become available that is particularly useful in dealing with or otherwise surmounting some condition that may likely arise upon the occurrence of a particular kind of catastrophic event. In such a case, maintaining such supplies can readily accommodate updating the acquired and stored emergency survival items to include a supply of this new item.

Referring again to FIG. 7, the mobile shelter 700 may comprise, at least in part, environmental protection 702 for authorized beneficiaries of the subscriptions. By one approach, such a shelter 700 can be provided with an independent source of breathable oxygen. When such is not the case, or when a back-up capability is also sought, an airway can be provided to permit air to be taken in to the shelter 700. In at least some cases, of course, this air may be dangerous in greater or lesser degrees to persons within the shelter 700. Therefore, a given shelter 700 may further optionally comprise protection, such as an air filter, from dangerous airborne contaminants (such as radiological contaminants, biological contaminants, and/or chemical contaminants, including both man-made and natural contaminants) as may correspond, for example, to a civilly-catastrophic event. A filtered air supply can then be provided for the occupants of the mobile shelter 700. Various air filters are known in the art and require no further elaboration here.

If desired, this air filter can further comprise an air drawer to draw air into the shelter 700. A variety of such air drawers are known in the art and include electrically powered air drawers, human powered air drawers, and so forth. By one approach this air drawer can be of sufficient size and power to create positive air pressure in the shelter 700 as compared to external ambient conditions. This, in turn, can aid in discouraging airborne contaminants from entering the shelter via whatever cracks, seams, and other openings may be present in the shelter's structure. Various ways and means are known in the art by which to provide positive air pressure in a contained space and therefore require no further detailed description here. Alternatively (or in combination with the above approaches), the shelter 701 can be configured to include masks, hoods, or other contrivances to facilitate delivering safe breathing gases to the occupants when the ambient environment may be dangerous to breathe.

Such approaches as those described above can comprise a part of an overall environmental protection plan for the shelter 700, the general purpose of which is to reduce or fully abate one or more external threats to the inhabitants of the shelter 700. At least some such threats, of course, will typically comprise extraordinary threats that are caused by, or otherwise attend or follow, the kinds of civilly-catastrophic events as can trigger the aforementioned right to access the shelter 700.

The mobile shelter 700 will also typically comprise at least one door 703 or other controlled point of ingress and egress to accommodate the entry and exit of the authorized beneficiaries. An additional controlled point of ingress and egress may be provided to provide an alternate means of entry and exit. By one approach the point of ingress/egress comprises a sealable point of ingress/egress and hence provides a relatively air-tight seal when closed to thereby further aid with preventing local airborne contaminants from entering the mobile shelter 700. This point of ingress/egress may further be provided with a locking mechanism to permit selective control with respect to accessing the mobile shelter 700. By one approach, the door 703 is configured and arranged to open inwardly. This, in turn, permits the door 703 to be opened even when, for example, debris or other obstructions are present in the immediate external vicinity of the door 703. Further, the security of the mobile shelter will typically benefit by use of controlled points of ingress/egress.

If desired, the controlled point of ingress and egress may comprise a first door and a second door in series, wherein the first door must close before the second door may open. This configuration can assist in substantially preventing contaminants from entering into the interior of the shelter. The first door and the second door have a space therebetween filled with air, and the air between the first door and the second door is filtered, circulated and replaced after the first door closes and before the second door is open. Having two doors in series may also assist in maintaining the security of the shelter.

In some cases it may be useful or desirable to provide 110 (FIG. 1) at least one substantially full-time attendant 704 or other personnel at the mobile shelter 700. Such a person can ensure that access requirements and restrictions are observed, that stored supplies remain maintained and free from interference or disturbance, that security of the shelter has not been breached, and that various other rules or regulations as may apply in a given setting are observed. In addition, the attendant may be available to facilitate operation of the mobile shelter in response to a civilly-catastrophic event. Thus, for example, the attendant may drive or pilot a self-powered mobile shelter, or may facilitate connecting a non-self-powered mobile shelter to a self-powered vehicle. Other duties or responsibilities are also possible if desired. By one approach the shelter 700 can also comprise living quarters such that the at least one attendant 704 is available to facilitate substantially immediate access to the mobile shelter 700 in response to a civilly-catastrophic event.

Referring again to FIGS. 1 and 7, the process 100 may comprise provisioning 111 the mobile shelter 700 with a defensive system 708. The defensive system may comprise any of a variety of non-lethal defensive protections for the shelter. For example, a loud noise may be emitted upon a breach of the security of the shelter. By another approach, an electric current may be applied to the exterior of the shelter, such that an unauthorized individual may receive an electric shock when trying to gain access to the shelter. The defensive system may include a smoke launcher that can substantially obscure the mobile shelter in a shroud of smoke. This may be accomplished, for example, by disposing an oil mixture on or in a hot engine manifold of the mobile shelter, with the oil mixture burning to create opaque smoke. Numerous other defensive systems are known in the art. The defensive system may be automatic (for example, by automatically operating in a predefined manner), partially automatic (for example, requiring some external prompting or control), and/or non-automatic (for example, requiring an individual to authorize use of the system upon detection of a breach).

Again referring to FIGS. 1 and 7, the process 100 may further comprise provisioning 112 the mobile shelter 700 with two-way communications facilities 705. The two-way communications facilities 705 can then be used for authorized beneficiaries or an attendant to communicate to another person, entity, or device that is external to the mobile shelter. These two-way communications facilities 705 can comprise wireless and/or non-wireless audio, video, and/or data communications of choice, to name but a few options. The wireless communications equipment includes, but is not limited to, equipment using carriers of essentially any useful frequency, terrestrial and/or satellite-based infrastructure, infrastructureless platforms, and so forth. Numerous such platforms and techniques are known in the art.

By another approach, if desired, the mobile shelter may also include a location beacon receiver. The beacon or other transmission may be sourced from, or near, the mobile shelter. The beacon can thus facilitate authorized beneficiaries in locating the mobile shelter. In such a case the corresponding authorized beneficiaries could be supplied with a device that is configured and arranged to locate the homing signal or information and aid the authorized beneficiary with navigating to that location. Further, the beacon can also alert rescuers and/or other personnel of the location of the mobile shelter to thereby facilitate rescue and/or tracking of the position of the shelter.

The mobile shelter 700 may also be provisioned 113 with external environment monitoring tools 706. The external environment monitoring tools 706 can then be used to monitor the conditions of the shelter's outer surroundings. Such capabilities may be particularly useful in determining whether or not clear and present threat exposure has been diminished or eliminated and, therefore, whether it is safe for the occupants to emerge from the mobile shelter. The external environment monitoring tools may comprise at least one of: a periscope, a window, a porthole, video transmissions, still image transmissions, and local sensors, forward looking infrared radar, night vision equipment, thermal imaging device, and radar to note but a few. Such tools may provide information related to external temperature, air quality, environmental conditions, location, approaching or nearby structures or beings, and the scope of damage as created by the occurrence of the catastrophic event. Such information may be helpful in determining the appropriate time for the occupants of the shelter to emerge from the shelter into the external environment, for the mobile shelter to attempt movement, and so forth.

These teachings can also optionally provide for monitoring the mobile shelter to detect when a person at least attempts to access the interior of the shelter. Such monitoring can serve, for example, to detect when unauthorized access is being attempted and/or to detect when a need for shelter exists. By one approach, this monitoring can comprise, at least in part, use of the aforementioned two-way communications facilities to permit communications with person within the interior of the shelter. By other approaches, this monitoring can be based, at least in part, on other visual, audio, telephonic, or wireless-based signals that suggest or confirm occupancy of the shelter.

So configured and arranged, a given individual can be assured of greatly improving a likelihood that they will survive the initial stages of a catastrophic event. This predictable and concrete result occurs notwithstanding a potential lack of other preparations on the part of the authorized beneficiary. Such benefits are also accruable, at least in many application settings, with little or no public notice or attention.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept.

We claim:

1. A method comprising:
providing a mobile shelter;
accepting consideration-based private civil security subscriptions from subscribers with respect to providing civilly-catastrophic event-based access to the mobile shelter.

2. The method of claim 1 wherein the mobile shelter comprises a short-term mobile shelter.

3. The method of claim 1 wherein the mobile shelter comprises a long-term mobile shelter.

4. The method of claim 1 wherein providing the mobile shelter comprises prepositioning the mobile shelter at a predetermined location.

5. The method of claim 4 wherein prepositioning the mobile shelter at a predetermined location comprises assessing a likelihood of at least one particular event occurring and a likelihood of a location where the at least one particular event would occur.

6. The method of claim 4 wherein prepositioning the mobile shelter at a predetermined location comprises prepositioning the mobile shelter at a predetermined location in relative proximity to a plurality of authorized beneficiaries of the consideration-based private civil security subscriptions.

7. The method of claim 4 wherein the mobile shelter is configured and arranged to be moved to and from the predetermined location.

8. The method of claim 7 wherein the mobile shelter is configured and arranged to be moved to and from the predetermined location during at least one of:
before;
during;
after
the civilly-catastrophic event.

9. The method of claim 4 wherein the mobile shelter remains stationary in the predetermined location while authorized beneficiaries of the consideration-based private civil security subscriptions occupy the mobile shelter.

10. The method of claim 1 wherein the mobile shelter is configured and arranged to transport authorized beneficiaries to at least one of:
another mobile shelter;
a fixed short term shelter;
a fixed long term shelter.

11. The method of claim 1 wherein the mobile shelter comprises at least one of:
a self-powered mobile shelter;
a non-self-powered mobile shelter.

12. The method of claim 1 wherein the mobile shelter is configured and arranged to be transported by a self-powered vehicle.

13. The method of claim 1 further comprising:
provisioning the mobile shelter with at least one of:
a wheel;
tracks;
rails;
a jet;
a float;
a hull;
a pontoon;
a propeller;
a skid;
to facilitate movement of the mobile shelter.

14. The method of claim 1 wherein the mobile shelter is configured and arranged to travel compatibly on or in at least one of:
paved surfaces;
unpaved surfaces;
railroad tracks;
a liquid medium;
an atmospheric medium;
earth.

15. The method of claim 1 wherein the mobile shelter comprises a vehicle.

16. The method of claim 15 wherein the vehicle comprises at least one of:
an air-borne vehicle;
a terrestrial vehicle;
a water-borne vehicle;
a hovercraft;
an amphibious vehicle;
a pilotless vehicle;
a remotely piloted vehicle;
a subterranean vehicle.

17. The method of claim 1 wherein providing a mobile shelter comprises providing a plurality of mobile shelters.

18. The method of claim 17 wherein the subscription provides event-based access to more than one of the plurality of mobile shelters.

19. The method of claim 17 wherein the subscription provides event-based access to any of the plurality of mobile shelters.

20. The method of claim 17 further comprising:
coupling at least two of the plurality of mobile shelters such that a self-powered vehicle can simultaneously transport the at least two mobile shelters.

21. The method of claim 20 wherein coupling at least two of the plurality of mobile shelters comprises interconnecting the at least two of the plurality of mobile shelters in a series.

22. The method of claim 20 wherein coupling at least two of the plurality of mobile shelters comprises stacking together the at least two of the plurality of mobile shelters.

23. The method of claim 17 wherein at least one of the plurality of mobile shelters comprises accommodations and features that differ from another one of the plurality of mobile shelters.

24. The method of claim 23 wherein the subscriptions differ from one another with respect to which accommodations and features are accessible as per the subscription.

25. The method of claim 1 wherein the mobile shelter comprises, at least in part, environmental protection for authorized beneficiaries of the subscriptions.

26. The method of claim 25 wherein the environmental protection comprises a positive pressure air capability to discourage airborne contaminants from entering the mobile shelter.

27. The method of claim 26 wherein the airborne contaminants comprise at least one of:
radiological contaminants;
biological contaminants;
chemical contaminants.

28. The method of claim 25 wherein the environmental protection comprises a filtered air supply.

29. The method of claim 1 wherein the mobile shelter comprises an enclosed structure.

30. The method of claim 1 wherein the mobile shelter comprises, at least in part, a controlled point of ingress and egress.

31. The method of claim 30 wherein the mobile shelter comprises, at least in part, at least one additional controlled point of ingress and egress.

32. The method of claim 30 wherein the point of ingress and egress comprises a sealable point of ingress and egress.

33. The method of claim 32 wherein the sealable point of ingress and egress comprises a door that opens inwardly.

34. The method of claim 32 wherein the sealable point of ingress and egress comprises a locking mechanism such that access to the mobile shelter is selectively controllable.

35. The method of claim 30 wherein the controlled point of ingress and egress comprises a first door and a second door in series, wherein the first door must close before the second door opens.

36. The method of claim 35 wherein the first door and the second door have a space therebetween filled with air, and the air between the first door and the second door is filtered, circulated and replaced after the first door closes and before the second door is open.

37. The method of claim 1 wherein the mobile shelter comprises at least one of:
a substantially fireproof mobile shelter;
a substantially waterproof mobile shelter;
a submergible mobile shelter;
a fortified mobile shelter;
a floating mobile shelter;
an armored mobile shelter;
a subterranean mobile shelter.

38. The method of claim 1 wherein the mobile shelter is configured and arranged to be disposed underground.

39. The method of claim 1 wherein the mobile shelter is at least substantially enclosed in a radiation-blocking barrier.

40. The method of claim 1 wherein providing a mobile shelter comprises providing a mobile shelter that has at least its critical vulnerable systems substantially protected against an electromagnetic pulse.

41. The method of claim 1 wherein the subscriptions comprise at least one of:
time-limited rights of access;
event-limited rights of access;
inheritable rights of access;
rights of access predicated upon a series of periodic payments;
rights of access predicated upon a one-time payment;
ownership-based rights of access;
non-transferable rights of access;
transferable rights of access;
membership-based rights of access;
fractionally-based rights of access;
non-ownership-based rights of access;
option-based rights of access.

42. The method of claim 1 wherein the civilly-catastrophic event comprises at least one of:
a natural disaster;
a non-naturally-caused disaster.

43. The method of claim 1 further comprising:
confirming identities of authorized beneficiaries gaining access to the mobile shelter.

44. The method of claim 43 wherein the identities of the authorized beneficiaries are confirmed by at least one of:
biometrics;
an identification card;
photographs;
visual confirmation;
an admission card;
a password;
a pass code;
a voice print;
words;
signature.

45. The method of claim 43 further comprising:
upon confirmation of the authorized beneficiary's identity, notifying at least one designated contact person upon the authorized beneficiary's entry into the mobile shelter.

46. The method of claim 1 further comprising:
maintaining the mobile shelter pending a need to permit subscription-based access to the mobile shelter upon occurrence of the event.

47. The method of claim 1 further comprising:
providing survival items in the mobile shelter.

48. The method of claim 47 further comprising:
making adjustments to the survival items in the mobile shelter to reflect dynamically changing circumstances as occur during the consideration-based private civil security subscription.

49. The method of claim 47 wherein providing survival items comprises providing a plurality of life-sustaining resources as pertain to a plurality of differing categories of life's necessities.

50. The method of claim 49 wherein the plurality of life-sustaining resources comprise at least one of:
hydration;
nourishment;
shelter;
clothing;
security;
medical treatment;
environmentally borne threat abatement.

51. The method of claim 47 wherein the survival items comprise at least one of:
consumable survival supplies;
non-consumable survival supplies.

52. The method of claim 51 wherein the consumable survival supplies comprise at least one of:
food supplies;
potable water;
finite air supply;
medical supplies;
batteries;
ammunition;
hygiene supplies;
sanitation supplies;
supplemental vehicular fuel supplies.

53. The method of claim 51 wherein the non-consumable survival supplies comprise at least one of:
essential clothing items;
personal protection items;
bed linens;
beds;
food preparation items;
communications items;
power generation equipment;
repair and maintenance tools;
evacuation tools;
navigation equipment;
rescue tools and supplies;
radiation shielding;
biological/chemical agent protection;
spare vehicle parts;
self-rescue gear;
vehicular maintenance tools;
weapons.

54. The method of claim 1 further comprising:
providing at least one non-necessity of human life in the mobile shelter.

55. The method of claim 54 wherein the at least one non-necessity of human life comprises at least one of:
a luxury consumable item;
a luxury non-consumable item;
non-human accommodations and nourishment;
barter medium;
an entertainment apparatus;
an educational tool;
physical conditioning, exercise, and maintenance training and equipment;
crafts supplies and training;
sports equipment and facilities.

56. The method of claim 1 wherein the mobile shelter comprises storage space.

57. The method of claim 1 further comprising:
providing at least one at least substantially full-time attendant at the mobile shelter.

58. The method of claim 57 wherein at least one at least substantially full-time attendant at the mobile shelter is available to facilitate operation of the mobile shelter in response to a civilly-catastrophic event.

59. The method of claim 1 further comprising:
provisioning the mobile shelter with a defensive system.

60. The method of claim 58 wherein the defensive system comprises at least one of:
an automatic defensive system;
a partially automatic defensive system;
a non-automatic defensive system.

61. The method of claim 1 wherein the mobile shelter comprises, at least in part, a location beacon receiver.

62. The method of claim 1 further comprising:
provisioning the mobile shelter with two-way communications facilities.

63. The method of claim 1 further comprising:
provisioning the mobile shelter with external environment monitoring tools;
using the external environment monitoring tools to monitor the conditions of the external environment.

64. The method of claim 63 wherein the external environment monitoring tools comprise at least one of:
a periscope;
video transmission;
still image transmission;
local sensors;
windows;
portholes;
forward looking infrared radar;
night vision equipment;
thermal imaging device;
radar.

65. The method of claim 1 further comprising:
providing mobile shelter location information to authorized beneficiaries.
